(19) United States
(12) Patent Application Publication
(10) Pub. No.: US 2025/0070864 A1
(43) Pub. Date: Feb. 27, 2025

(54) METHODS, DEVICES, AND SYSTEMS FOR ON-ORBIT AUTONOMOUS RECOVERY OF SATELLITES

(71) Applicant: Antaris Inc., Los Altos, CA (US)

(72) Inventors: Karthikeyan Govindhasamy, Fremont, CA (US); Spencer Eggert, Sammamish, WA (US); Sivakumar Govindassamy, Irvine, CA (US)

(21) Appl. No.: 18/813,612

(22) Filed: Aug. 23, 2024

Related U.S. Application Data
(60) Provisional application No. 63/578,547, filed on Aug. 24, 2023.

(51) Int. Cl. H04B 7/185

(52) U.S. Cl. CPC H04B 7/18519; H04B 7/18547; H04B 7/18582

(57) ABSTRACT

Systems, methods, and devices in a satellite for on-orbit recovery are described. The device includes a plurality of circuits that are electrically connected to a backplane of the device, and a controller configured to monitor parameters of at least one of the plurality of circuits, and configured to store the parameters that are monitored with respective timestamps and respective orbit locations of the satellite. The controller is further configured to identify an error of a first circuit of the plurality of circuits based on the parameters that are monitored and the respective orbit locations of the satellite.

### CROSS-REFERENCE TO RELATED APPLICATION

The present application claims the benefit of U.S. Provisional Patent Application Ser. No. 63/578,547, filed Aug. 24, 2023, the disclosure of which is herein incorporated in its entirety by reference.

### FIELD

Various embodiments described herein relate to antenna systems.

### BACKGROUND

Man-made satellites are launched into space and orbit the earth. These satellites facilitate various applications such as communications, global positioning, data networking, imaging, weather information, emergency response, and/or military applications. Satellites may be in geosynchronous orbit (GSO)/geostationary orbit (GEO), low earth orbit (LEO), medium earth orbit (MEO), or a highly elliptical orbit (HEO). As satellites orbit the earth and perform various functions, the reliability and longevity of these satellites are important due to the expense and difficulty in launching and maintaining satellites.

### SUMMARY

Various embodiments of the inventive concept are directed to a device configured for satellite on-orbit recovery. The device includes a plurality of circuits that are electrically connected to a backplane of the device wherein the device is configured to operate in a satellite, and a controller configured to monitor parameters of at least one of the plurality of circuits, and configured to store the parameters that are monitored with respective timestamps and respective orbit locations of the satellite. The controller is further configured to identify an error of a first circuit of the plurality of circuits based on the parameters that are monitored and the respective orbit locations of the satellite.

According to some embodiments, the controller may be further configured to perform a recovery operation on the first circuit, responsive to predicting or detecting the error. The recovery operation may include modifying operation of the first circuit by temporarily pausing the operation of the first circuit, switching the operation to a second circuit of the plurality of circuits that is redundant to the first circuit, and/or reducing data transmission rate of the first circuit. The controller may be further configured to provide feedback to the first circuit responsive to predicting or detecting the error based on the parameters that are monitored and the respective orbit locations of the satellite. An operation of the first circuit may be modified based on the feedback and one of the respective orbit locations of the satellite. The feedback may include at least one of satellite location, data rate of data transmitted by the first circuit, or processing load of the first circuit. The first circuit may be deactivated responsive to the predicting or detecting the error, and a second circuit that is redundant to the first circuit is activated. Data related to the parameters of ones of the plurality of circuits may be stored for a plurality of orbit locations and/or for a plurality of orbits of the satellite, and the data related to the parameters for the plurality of orbit locations and/or for the plurality of orbits of the satellite may be used to train an artificial intelligence engine, and the artificial intelligence engine may be configured to predict the error of the first circuit. The controller may be configured to modify operation of the first circuit based on the error predicted by the artificial intelligence engine. The parameters may include electrical properties of power distribution from the backplane to ones of the plurality of circuits. The error of the first circuit is identified if at least one of the electrical properties of the power distribution from the backplane is below respective threshold values.

Various embodiments of the inventive concept are directed to a method of operating a device configured for satellite on-orbit recovery. The method includes monitoring parameters of at least one of a plurality of circuits that are electrically connected to a backplane of the device while a satellite is in orbit, storing data related to the parameters that are monitored with respective timestamps and respective orbit locations of the satellite during a plurality of orbits of the satellite, and identifying an error of a first circuit of the plurality of circuits based on the data related to the parameters that are monitored and the respective orbit locations of the satellite.

According to some embodiment, the method may include performing a recovery operation of the first circuit, responsive to predicting or detecting of the error. Performing the recovery operation may include modifying operation of the first circuit by temporarily pausing the operation of the first circuit, switching the operation to a second circuit of the plurality of circuits that is redundant to the first circuit, and/or reducing a data transmission rate of the first circuit. The method may include providing feedback to the first circuit responsive to predicting or detecting of the error based on the parameters that are monitored and the respective orbit locations of the satellite, and modifying operation of the first circuit based on the feedback and a present orbit location of the satellite. The feedback may include at least one of satellite location, data rate of data transmitted by the first circuit, or processing load of the first circuit. The method may further include deactivating the first circuit responsive to predicting or detecting of the error, and activating a second circuit of the plurality of circuits that is redundant to the first circuit. The method may further include training an artificial intelligence engine using the data related to the parameters for the respective orbit locations for the plurality of orbits of the satellite, and predicting, by the artificial intelligence engine, the error of the first circuit. The method may further include modifying operation of the first circuit based on the error predicted by the artificial intelligence engine. The parameters may include electrical properties of power distribution from the backplane to ones of the plurality of circuits. The method may further include identifying the error of the first circuit if at least one of the electrical properties of the power distribution from the backplane is below respective threshold values.

Various embodiments of the inventive concept are directed to a method of operating a device configured for satellite on-orbit recovery. The method includes monitoring parameters of at least one of a plurality of circuits that are electrically connected to a backplane of the device while a satellite is in orbit, storing data related to the parameters that are monitored with respective timestamps and respective orbit locations of the satellite during a plurality of orbits of the satellite, and training an artificial intelligence engine using the data related to the parameters for the orbit locations and for the plurality of orbits of the satellite, and predicting, by the artificial intelligence engine, an error of a first circuit of the plurality of circuits based on the data related to the parameters that are monitored and the respective orbit locations of the satellite.

According to some embodiments, the method may include responsive to the predicting the error by the artificial intelligence engine, modifying operation of the first circuit by temporarily pausing the operation of the first circuit and/or switching the operation to a second circuit of the plurality of circuits that is redundant to the first circuit.

### BRIEF DESCRIPTION OF THE DRAWINGS

The accompanying drawings, which are included to provide a further understanding of the present disclosure and are incorporated in and constitute a part of this application, illustrate example embodiment(s). In the drawings:

FIG. 1 illustrates a satellite system, according to various embodiments.

FIG. 2 illustrates a high level platform architecture for a satellite, according to various embodiments.

FIGS. 3 to 22 illustrate the architecture and design layout for a satellite system, according to various embodiments.

FIGS. 23 to 32 are flowcharts of operations of a device configured for satellite on-orbit recovery, according to various embodiments.

### DETAILED DESCRIPTION

Example embodiments of the present inventive concepts now will be described with reference to the accompanying drawings. The present inventive concepts may, however, be embodied in a variety of different forms and should not be construed as limited to the embodiments set forth herein. Rather, these embodiments are provided so that this disclosure will be thorough and complete, and will fully convey the scope of the present inventive concepts to those skilled in the art. In the drawings, like designations refer to like elements.

Hardware and software that are used on a satellite need to be highly secure and capable of self-recovery in the event of on-orbit anomalies. Desired features for satellite hardware and software include highly modular designs, self-healing and self-recovery capabilities, fault tolerant architectures, secure access to controlling the satellite, system-wide resiliency, and improved satellite lifespan. Systems and designs of commercial satellites particularly need to be resilient, highly efficient in performance, and have a long lifespan.

Various embodiments of the present inventive concepts arise from the recognition for a need for autonomous fault prevention and recovery of satellite functions. Failure avoidance may be accomplished through AI-based fault detection and recovery using telemetry histograms and machine learning algorithms. Machine learning algorithms at the satellite may be trained through onboard telemetry and space/cloud based situational awareness. Hardware and software methodologies may be used to detect failure modes even before the primary system failure is triggered. Automatic recovery may be performed at the component level through software fault detection.

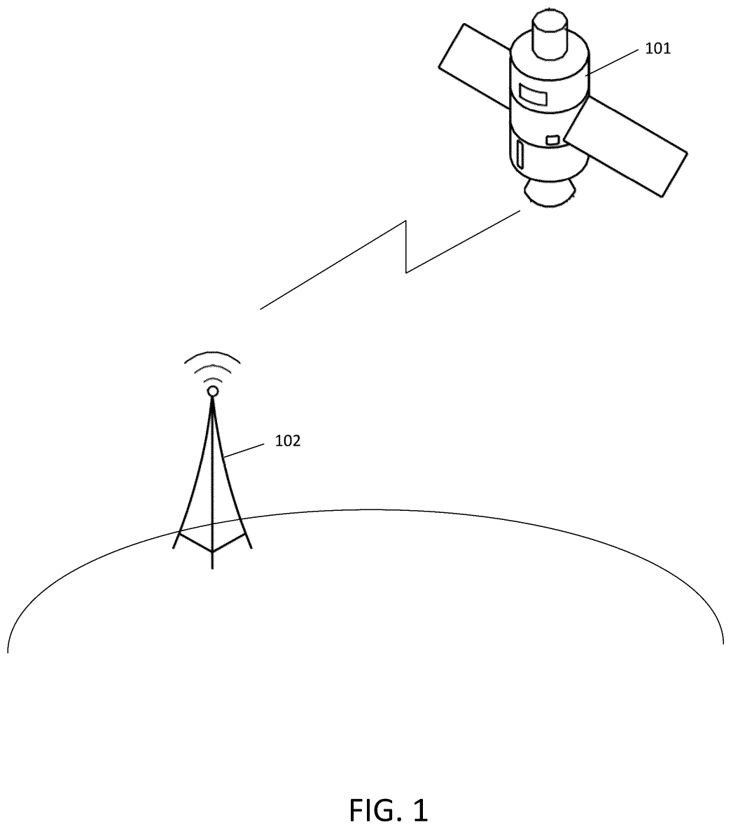

FIG. 1 illustrates a satellite system, according to various embodiments. Referring to FIG. 1, a satellite 101 may be in communication with a terrestrial base station or ground station 102. The satellite may include a device configured for satellite on-orbit recovery and fault prevention. Automatic recovery may be accomplished at the subsystem level through software and hardware fault detection. Automatic recovery and switchovers at the main onboard computer level, such as at a core processor or at the main onboard controller, may be accomplished through software fault detection and power sensing. The architecture and design layout may share the I/O with multiple compute instances for automatic recovery and failover. These multiple instances may be redundant elements in the system.

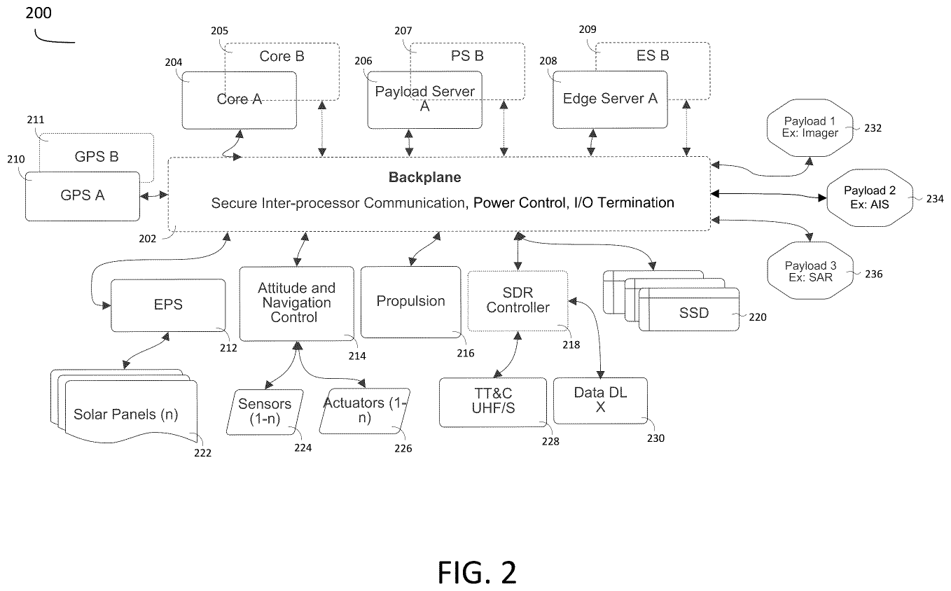

FIG. 2 illustrates a high level platform architecture for a satellite. Referring to FIG. 2, the device 200 may be in satellite 101 of FIG. 1. The device 200 may include backplane I/O interface 202 (also referred to as a “backplane”) that is configured to connect modular compute nodes with flexible I/O cable interconnects. Some of the elements may be redundant, such as core A 204 and core B 205, payload server A 206 and payload server B 207, or edge server A 208 and edge server B 209. A multiplexer (mux) based network port selection mechanism may be used for connection from the backplane 202 to the active one of the redundant elements. For example, core A 204 and core B 205 may be connected by a multiplexer to the backplane 202. Network port monitoring may be performed by one or more elements of the platform for failure detection and automatic recovery. Redundant (1G Ethernet, PCIe) high speed I/O interface sensors 224/payloads 232, 234, 236 interconnect the various redundant elements to one another. Contention avoidance and a low latency data interface are needed for interconnecting the various redundant elements. For example, a mux selectable ethernet interface may be used for radio modules. A multiplexer-based memory/storage interconnect strategy may be used. Shared memory/storage may be used across processors/computes. Backplane 202 may use a smart I/O pin orientation for compact hardware layout. Backplane 202 may further connect to various circuits such as an Electrical Power System (EPS) 212, attitude and navigation control circuit 214, propulsion 216, an SDR controller 218, and/or solid state devices (SSD) 220. The SDR controller 218 may communicate with a data DL 230 and/or a telemetry, tracking, and control (TT&C) UHF/S 228. Sensors 224 and actuators 226 may provide data to the attitude and navigation control circuit 214. Solar panels 222 may be coupled to the EPS 212.

Still referring to FIG. 2, core A 204 may be the primary bus onboard controller (OBC) which terminates various I/O for bus command and control. In case of a primary bus OBC failure or lock-up, core B 205 is activated and takes control of the bus that connects to backplane 202. Core B 205 can diagnose a core A 204 problem (and vice versa) and repair core A 204, either automatically or through ground telecommands that are responsive to core B 205 informing the ground station. Since both core A 204 and core B 205 share a common I/O bus, the subsystems functions are not impacted.

Still referring to FIG. 2, one of core A 204 or core B 205 may be the active core OBC. The failover and auto-recovery may be based on power and data sensing by the core OBC and/or memory. For example, if power is interrupted to the core OBC or if the data is interrupted to the core OBC, a switchover to the redundant core may be initiated. In some embodiments, more than two core OBCs may be in the system.

Still referring to FIG. 2, payload server A 206 may be the primary payload OBC which terminates various I/O for high speed data and other compute node interconnectivity. In case of primary payload server failure or lock-up, payload server B 207 is activated and continues the payload server tasks. Payload server B 207 and/or the active core OBC (core A 204 or core B 205) may be able to diagnose the payload server problem and repair it, either automatically or through ground telecommands. Since both payload server A 206 and payload server B 207 share the common I/O bus, the subsystems functions are not impacted by switching between the payload servers. The failover and auto-recovery may be triggered through power and data sensing of the payload OBC and/or memory. The core OBC may monitor the power and data interface of the payload OBC for failure detection and recovery. In some embodiments, more than two payload servers may be included in the system. The payload server facilitates various applications such as payloads 232, 234, and 236, which for example, may include image processing, Automatic Identification System (AIS), and Synthetic Aperture Radio (SAR).

Still referring to FIG. 2, the Global Positioning System (GPS) may be used for satellite location tracking. Device 200 of the satellite may include GPS module redundancy and automatic recovery. GPS module A 210 may be the primary GPS receiver. In case of primary GPS receiver failure or lock-up or if unable to provide GPS data, GPS module B 211 may be activated. An OBC, such as an OBC in core A 204, can diagnose the GPS module problem and repair it automatically or through ground telecommands. Both GPS module A 210 and GPS module B 211 share a common I/O bus that is connected to the backplane 202, such that the switching between the GPS module A 210 and GPS module B 211 may be seamless to the other sub-systems. The failover and auto-recovery may use power and/or data sensing of the GPS module A 210 and GPS module B 211. A core OBC or a bus OBC in the GPS module may monitor the power and I/O interface of the GPS module for failure detection and recovery. In some embodiments, more than two GPS modules may be included in the system.

Network Port Redundancy & Automatic recovery is important for the satellite operations. Multiplexer or firmware controlled network port selection may be utilized. Network port failure detection and automatic recovery may be implemented for reliability. For example, a bus OBC may monitor the power and/or data interface of the payload OBC for failure detection and recovery. In some embodiments, multiple power channels may be used to power each node in the network, with separate sensors at each node to measure power. Network port partitioning may be implemented to avoid single point failures. Autonomous and/or ground telecommand driven network port diagnosis and recovery may be used.

According to some embodiments, failure avoidance may be accomplished through artificial intelligence (AI) based fault detection and recovery using telemetry histograms and/or machine learning algorithms at the satellite device. Machine learning algorithm are trained through onboard telemetry, and space/cloud based situational awareness may occur. Hardware and software methods to detect failure modes may be employed before the primary system failure is triggered. Monitoring the I/O interface (e.g., CAN, SPI, I2C, USB, UART, Ethernet, PCIe, GPIOs, LVDS etc.) of compute elements or processors, memory or storage, and other components may be accomplished by tracking the various parameters for each element, such as bit errors for both the receiver and the transmitter, electrical anomalies (e.g., voltage and current, expected vs. observed), temperature/thermal variations including system generated and sun exposure variations (expected vs. observed), data rate degradation (expected vs observed over a period of time), power ON/OFF time (expected vs observed), CPU core performance for processors with one or more cores, memory/storage sector performance (e.g., sector read/write errors), etc.

The aforementioned parameters that are monitored may be stored and/or retrieved with a corresponding timestamp and orbit location (GPS) information for reference. This data history may be built up over time, after many orbits of the satellite and be studied to determine predicted behavior or determine patterns. The historical data may be used to identify (i.e., detect or predict) orbit location based errors, use case based errors, and/or application interaction based errors. For example, a satellite may be collecting images of the terrain as it passes over the earth. At certain locations, data errors in the image transmission may be high, suggesting poor data rates at that location. At some locations, the thermal measurements of elements such as the core may be higher due to solar exposure or atmospheric drag at particular points in the orbit. In these cases, based on this information, the device may stop image collection in the offending location in order to reduce data transmission rates and/or core processing operations, thereby reducing the temperature of the device and/or improving overall image quality by not transmitting images during times of poor data rates. In some embodiments, image collection may still occur, but transmission of image data to terrestrial stations may be delayed until conditions improve.

According to some embodiments, real time feedback such as location, data rates, processing loads, etc. may be provided to various hardware elements or to various software applications to prevent errors and anomalies. By using AI models based on previously collected data, predictions about errors and anomalies may be made about particular times or satellite locations where these errors and anomalies are likely to occur. This feedback may be provided to specific applications to allow them to reduce or pause operation or subsystems or applications, switchover to a redundant hardware element, or increase resources for higher priority applications. Feedback may be provided to a terrestrial controller for operator action.

According to some embodiments, automatic recovery at the component level may be implemented through software fault detection. Automatic recovery at the subsystem level may be implemented through software and hardware fault detection. Automatic recovery and failover at main onboard compute level may be implemented through software fault detection and power sensing. Power sensing may involve detecting when the voltage, current, or power levels received at an element are below respective threshold values. The automatic detection of failures at the subsystem (e.g., processor, storage, memories, I/Os, network interconnects) may be achieved by using periodic keep alive messages and/or a configurable timer. A retry mechanism that includes a configurable timer for retries and/or a configurable retry count may be checked before declaring the subsystem failure. Multiple failover options for switchover may be available, each with configurable priority. For example, three processors in the system can be set with three different priority values and order of failover options. Similarly, priority options may be configured for memory, storage, IO connects, network interface, data interfaces, and other subsystems.

According to some embodiments, the system may be preconfigured with the error detection parameters, failover options with priority orders, error detection schemas, number of retries, time between the retries etc. From the ground station, the space satellite system may be controlled via telecommands and other communication methodologies to configure the error detection parameters, number of failover options with priority orders, error detection schemas, number of retries, time between the retries etc. Automatic fallbacks and/or failovers may follow the next priority order that was set for a failed subsystem. Ground station command based fallbacks and/or failovers may follow the next priority order that was set for a failed subsystem. As more data is obtained as the satellite orbits the earth, the AI models become better trained and provide more accurate detection or prediction of errors, such that more autonomous fallbacks and/or failovers may be relied upon for operation of the satellite systems. The AI processing may be accomplished at a device on board the satellite or at a ground station. For example, a compute or processor may be on board the satellite, and is configured to perform AI processing, then store telemetry data which is then processed on board the satellite. As another non-limiting example, a compute or processor for AI processing may not be available on board the satellite. In this case, the data may be downlinked to the ground stations and the AI processing may be run on the ground station computers. The results may be sent back to the satellite via telecommand for satellite command and control.

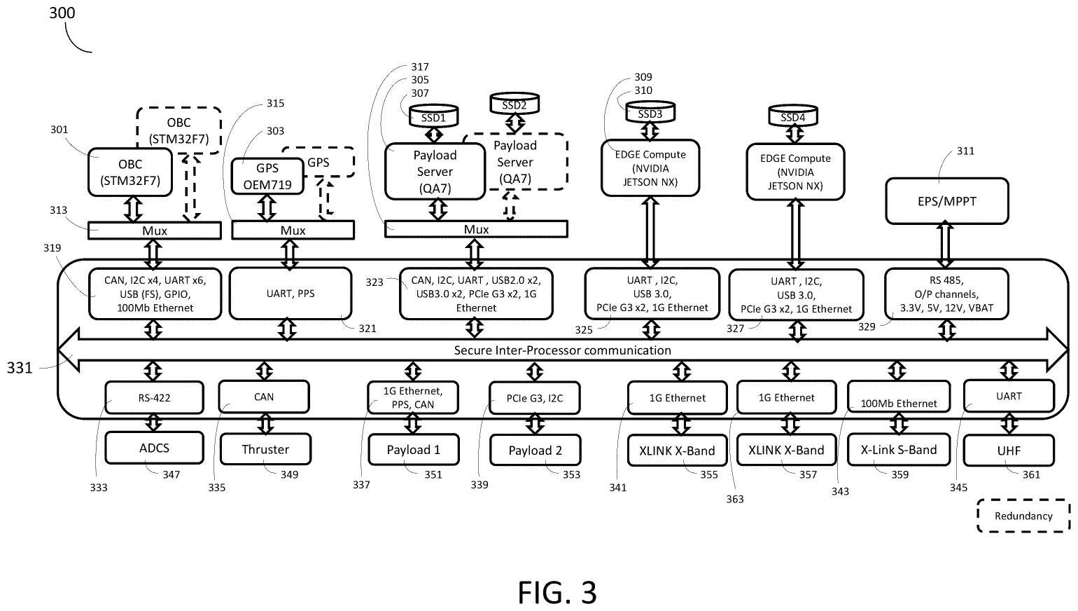

FIGS. 3 to 23 illustrate the architecture and design layout for a satellite system, according to various embodiments. The architecture may share the I/O with multiple compute instances for automatic recovery and failover. Referring to FIG. 3, device 300 may be part of satellite 101 of FIG. 1 or device 200 of FIG. 2. The On Board Controller (OBC) 301 is a core of the satellite, is a central compute node, and is responsible for managing and controlling various subsystems within the satellite avionics system. Redundancy for OBC 301 facilitates fault prevention and fault recovery. Payload Server (PS) 305 can enable the processing and management of payload data of the avionics system. Payload server may have a storage SSD 307. Redundancy for payload server 305 facilitates fault prevention and fault recovery. Edge Server (ES) 309 can enable the processing and management of payload data of the avionics system. In addition, edge server 309 also has the ability for AI edge computing. There may be two edge compute nodes (i.e., edge server 309) and both can be powered on simultaneously but the storage path to storage SSD 310 of only one of the edge servers 309 is selectable by the OBC 301 at a time. GPS 303 provides the avionics system with accurate location and timing information using Global Positioning System technology. In addition, GPS 303 may also provide a pulse per second (PPS) signal for time synchronization. Attitude Determination and Control System (ADCS) 347 may be an important subsystem in the satellite responsible for determining and maintaining the orientation and/or attitude of the satellite. Spacecraft attitude control is the process of controlling the orientation of a satellite with respect to an inertial frame of reference or another entity in space. In addition, ADCS 347 may also maintain the stability of the satellite and achieve precise pointing for payloads, communication antennas etc. Electrical Power System (EPS) 311, which may be an important component of a satellite that manages the generation, storage, and distribution of electrical power required to operate various subsystems in the avionics system. EPS 311 may also include Maximum Power Point Tracking (MPPT) to track voltages for a particular temperature and orientation of solar panels.

Still referring to FIG. 3, S Band Radio 359 may be used for low throughput communication between the ground station and satellite involving transmission and reception of telemetry, and telecommand functions. Telemetry involves sending satellite health and mission critical status information to the ground station and telecommand involves sending mission critical instructions from the ground to the satellite. X Band Radio 357 is used for high throughput communication between ground station and satellite involving transfer of mass payload data from satellite to ground station. UHF radio 361 is used as a backup mechanism for S band. UHF has a very low throughput communication between the ground station and satellite involving transmission and reception of telemetry, and telecommand functions. SAR Payload 351 is an active sensor payload capable of imaging during the day and/or night and is an all-weather sensor which can penetrate clouds and smoke. Multispectral Imaging (MSI) payload 353 is a payload that includes 7-spectral bands in the Visible and Near Infrared (VNIR) spectrum i.e., wavelength ranges between 400-900 nanometers for imaging from the low earth satellite orbit. This system is designed to be very flexible with various interconnects that supports different I/O interfaces to connect various payload hardware and control systems in the satellite. Key Features supported by this architecture include a distributed compute architecture, onboard networking, built in redundancy, highly resilient, flexible I/O interfaces, built in onboard storage, multiplexer enabled and software controlled, compactness, and modularity.

Still referring to FIG. 3, a secure inter-processor communication bus 331 may facilitate communication between various subsystems through various interfaces such as 100 Mb ethernet 319, 343, UART for PPS 321, 1G ethernet interfaces 325, 327, 337, 341, 363 RS-485 interface 329, RS-422 interface 333, CAN interface 335, PCIe interface 339, and UART 345. Other subsystems in device 300 may include thruster 349, payloads 351, 353, XLINK X-band radios 355, 357, X-link S-band radio 359, UHF radio 361.

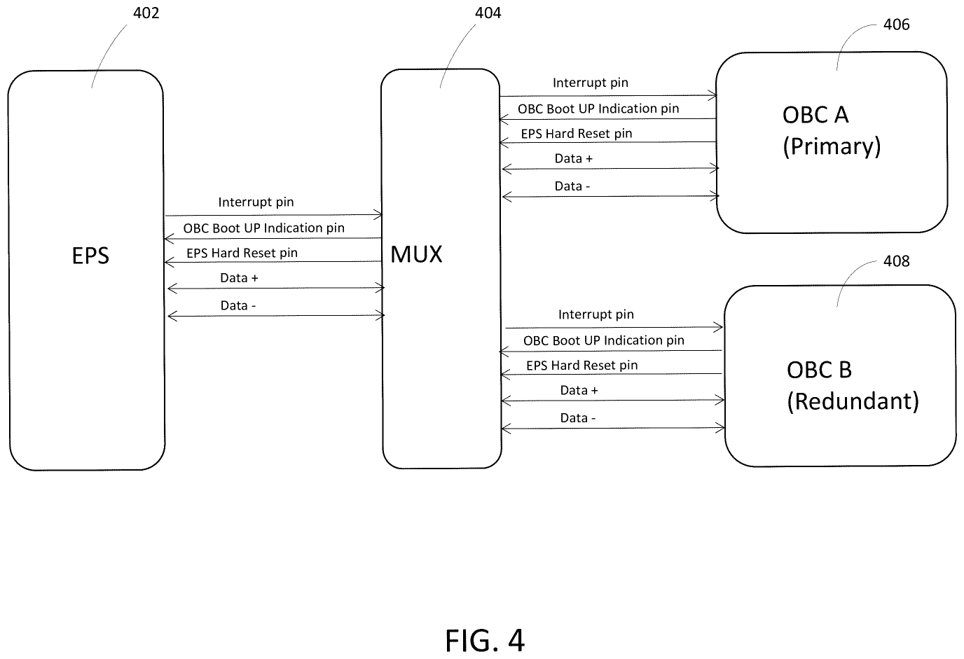

A primary OBC and a redundancy OBC may support the fallback mechanism. The power ON and OFF of the primary OBC and the redundant OBC is controlled by the hardware and software logic, as will be discussed with respect to FIG. 4. Referring to FIG. 4, primary OBC 406 and redundant OBC 408 are connected to the Electrical Power System (EPS) 402 through interfaces and/or through multiplexer 404 which includes interfaces such as RS-485 and GPIOs. Switching may occur between the primary OBC 406 and redundant OBC 408. During normal execution, EPS 402 powers ON the primary OBC 406. After the primary OBC 406 boots up, primary OBC 406 asserts the OBC boot UP signal within a pre-defined duration, that is software configurable, from power supply enable to the primary OBC 406. In case the primary OBC 406 fails to assert the Boot UP indication signal, EPS 402 will wait for a predefined timeout duration and then power cycle the primary OBC 406. The default and recommended total value for the retry count may be five, for example, for EPS 402 to power cycle the primary OBC 406 for failure of the Boot UP indication. The retry count is software configurable. After a pre-defined count of primary OBC 406 power cycle attempts, if failure persists, the EPS 402 will switch operation to the redundant OBC 408.

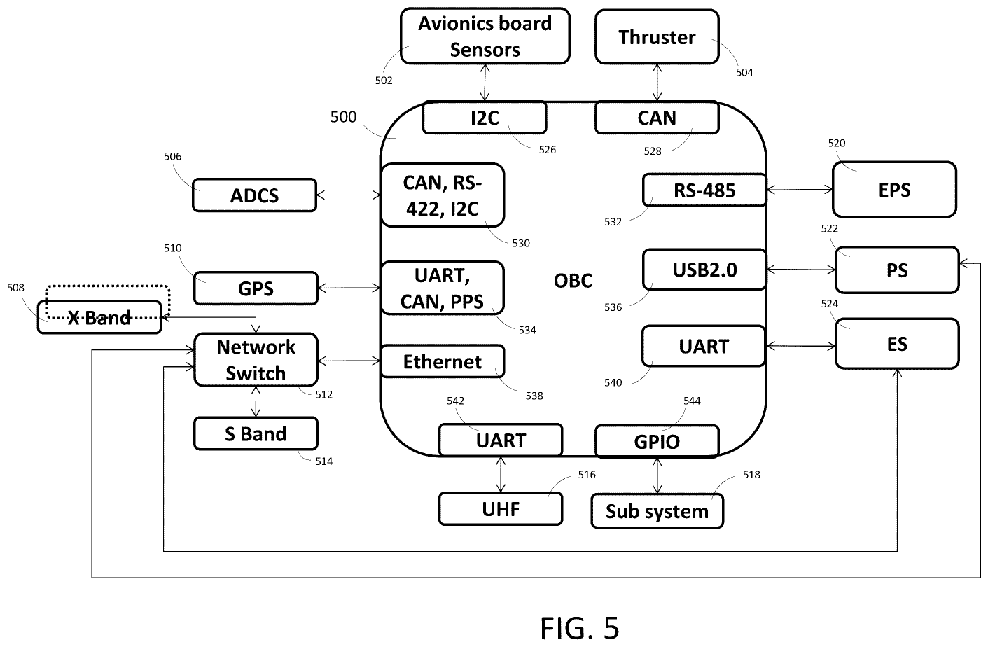

A high level connectivity diagram for the primary OBC 406 or the redundant OBC 408 of FIG. 4 is shown in FIG. 5. Referring to FIG. 5, OBC 500 is the central compute node present in the satellite avionics and is responsible for managing and controlling various subsystems within the satellite. OBC 500 is interconnected with the EPS 520 through RS-485 Interface 532. OBC 500 is automatically powered through an EPS interface by EPS 520, and OBC 500 in turn controls the power supply to other sub systems. OBC 500 is interconnected with the payload server (PS) 522 though the USB2.0 536 and ethernet (i.e., through an ethernet switch). The power supply for the payload server 522 is from EPS 520 and is controlled by OBC 500. The OBC 500 is interconnected with edge server (ES) 524 though UART 540 and ethernet (i.e., through an ethernet switch). The power supply for edge server 524 is from EPS 520 and is controlled by OBC 500. OBC 500 is interconnected with ADCS 506 though CAN/RS-422/I2C interface 530 and the power supply is from EPS 520, controlled by OBC 500. OBC 500 is interconnected with GPS 510 though UART/CAN interface 534 and the power supply to the GPS 510 is from EPS 520 controlled by OBC 500. OBC 500 is interconnected with avionics sensors 502 through I2C interface 526. Sensors 502 are powered by OBC 500 with the power derived from EPS 520. OBC 500 is interconnected with thrusters 504 through CAN interface 528 and the power supply is from EPS 520 controlled by OBC 500. OBC 500 is interconnected with X-band radio 508 and S-band radio 514 through ethernet. The power supply for these radios is from EPS 520 controlled by OBC 500. OBC 500 is interconnected with UHF 516 through UART 542 and the power supply is from EPS 520 controlled by OBC 500. OBC 500 is interconnected with other sub systems 518 through GPIOs 544 for monitor and enable purposes.

A wide range of interfaces like CAN, I2C, RS422 530 and GPIOs 544 may be used for supporting different ADCS modules 506. For example, an ADCS may be connected via RS422, and the power supply for the ADCS may be from EPS and under control of an OBC. A standard UART interface and CAN Interface may be used for GPS module interconnect. For example, an OEM719 is connected via UART to the OBC with power supply from the EPS under control of the OBC. A CAN interface may be used as an interconnect for thrusters. For example, thruster may be connected via CAN to the OBC with power supply from the EPS under control of the OBC. A UART interface may be used for UHF board interconnect. For example, the UHF Radio may be connected via UART to OBC with power supply from the EPS under control of the OBC. The OBC and PS may be interconnected through a board-to-board connector on the backplane board. The main interface between OBC and PS are USB2.0 and Ethernet. The OBC and the edge server may be interconnected through the board-to-board connector on the backplane board. The main interface between OBC and edge server are UART and Ethernet. The OBC and S band radio and the X band radio are interconnected via ethernet through the board-to-board and external connector.

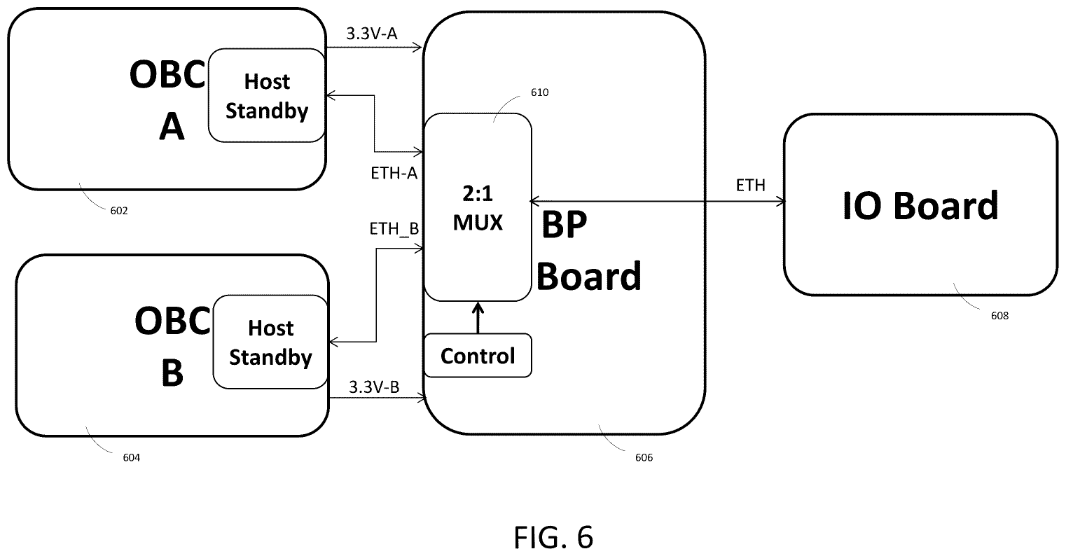

The avionics system may support OBC redundancy and the interfaces may be controlled through the multiplexer configuration. An ethernet multiplexer may be between the primary and redundant OBCs. Referring to FIG. 6, primary OBC 602 and redundant OBC 604 may be connected to the multiplexer 610 of the backplane board 606. An I/O board 608 is connected by ethernet to multiplexer 610. For whichever of the primary OBC 602 and redundant OBC 604 boards is powered on, the corresponding ethernet interface will be selected automatically, as will be further explained.

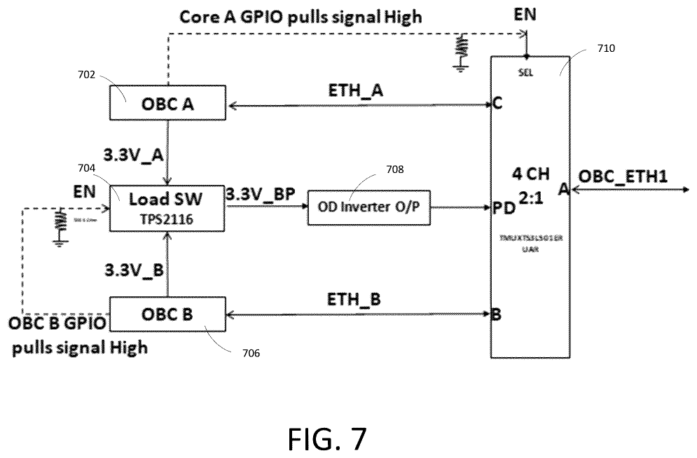

Referring to FIG. 7, 3.3V from primary OBC 702 and redundant OBC 706 are given to the load software 704, which is enabled by the GPIO of redundant OBC 706. By default, 3.3V_A is selected and the same is used to control the PD pin of 2:1 multiplexer 710. When redundant OBC 706 is enabled, 3.3V_B is selected and the same is used to control the PD pin of 2:1 multiplexer 710. The GPIO from the primary OBC 702 is used to control SEL pin of 2:1 multiplexer and by default, the redundant OBC 706 Ethernet is selected at the output. Once primary OBC 702 is turned on, primary OBC 702 pulls the SEL pin high and the primary OBC 702 Ethernet is selected at the output of MUX 710. The tables below provide a logic table for the MUX selection of FIG. 7.

| SEL | OBC_A | OBC_B | OUTPUT |
|---|---|---|---|
| OBC A GPIO pulls | ON | OFF | HIGH - ETH_A |
| signal High | | | |
| LOW(pull down) | OFF | ON | LOW - ETH_B |
| LOW | OFF | OFF | LOW - ETH_B |

| EN | OBC_A | OBC_B | OUTPUT |
|---|---|---|---|
| OBC B GPIO pulls | OFF | ON | 3.3V_B |
| signal High | | | |
| LOW(Pull down) | ON | OFF | 3.3V_A |
| LOW | OFF | OFF | 3.3V_A/0V |

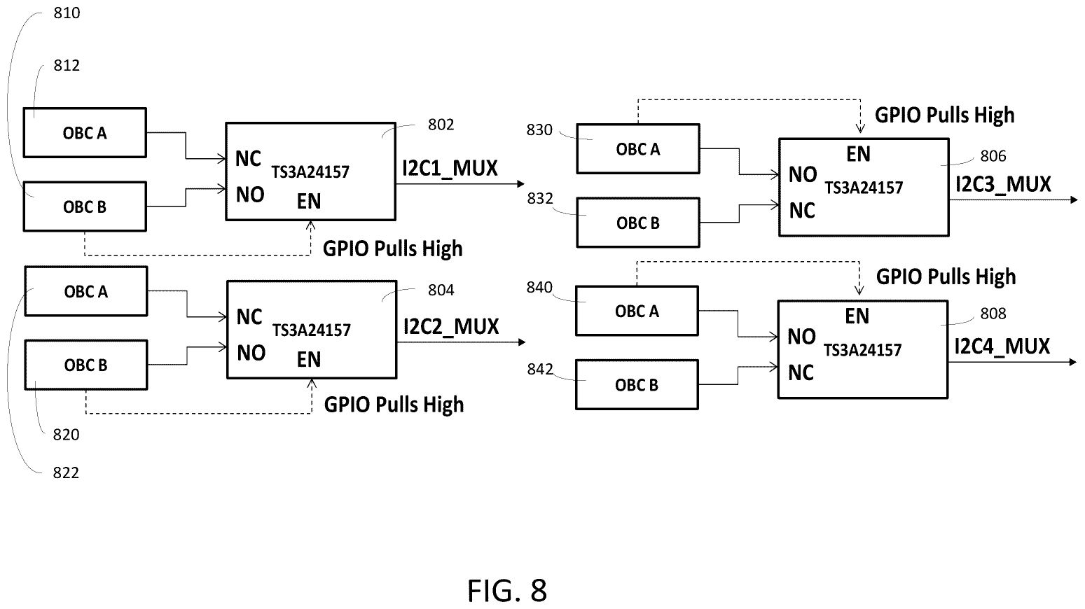

FIG. 8 illustrates I2C multiplexer selection. Referring to FIG. 8, four I2C multiplexers 802, 804, 806, and 808 are present in the example design shown in FIG. 8. Multiplexer 802 and multiplexer 804 are controlled by OBC 812 and OBC 822, respectively and multiplexer 806 and multiplexer 808 are controlled by OBC 830 and OBC 840, respectively. MUX 802, 804, 806, and 808 are operated according to the following truth table.

| IN | NC TO COM, COM TO NC | NO TO COM, COM TO NO |
|---|---|---|
| LOW | ON | OFF |
| HIGH | OFF | ON |

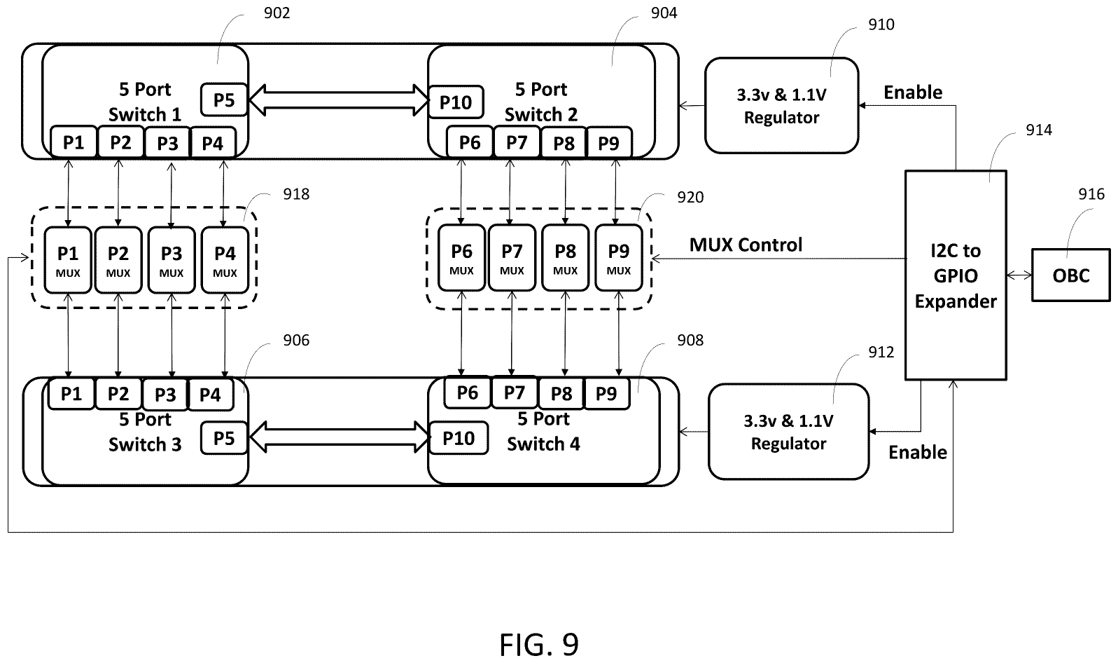

The satellite avionics system may include network switches. An example network interconnect and port multiplexing are shown in FIG. 9. Referring to FIG. 9, four network switches 902, 904, 906, and 908, each with five ports are shown. To enhance reliability and fault tolerance network on board, the network interconnect is built with multiple levels of redundancy and fail-safe mechanisms. The design may incorporate network switch level redundancy, network port level redundancy, and other high speed interface level redundancy with automated failover mechanisms controlled by the OBC 916. Network switch 906 is redundant for network switch 902, and network switch 908 is redundant for network switch 904. This redundancy ensures that if one switch fails, the redundant counterpart can take over operations and ensure seamless networking of the subsystem in the satellite. The failure detection and network switch selection are automatically handled by the OBC 916 via the network switch multiplexers 918, 920.

The network switches 902, 904, 906, and 908 may support a data transfer rate of 1 gigabit per second (Gbps) on each port. The network switches 902, 904, 906, and 908 facilitate data transfer among various components, including compute nodes, radio modules, and payload hardware.

Multiplexers 918, 920 are used to switch between the primary and redundant network switches, such as network switches 902, 906 and network switches 904, 908. This allows selection of the active path, providing flexibility and redundancy in the network interconnect. The OBC 916 controls the multiplexers 918, 920 switching through I2C using a GPIO expander 914. Out of five ports, four ports are used for sub systems interconnect and the remaining port in each of the network switches is used to interconnect amongst the network switches 902, 906 and network switches 904, 908.

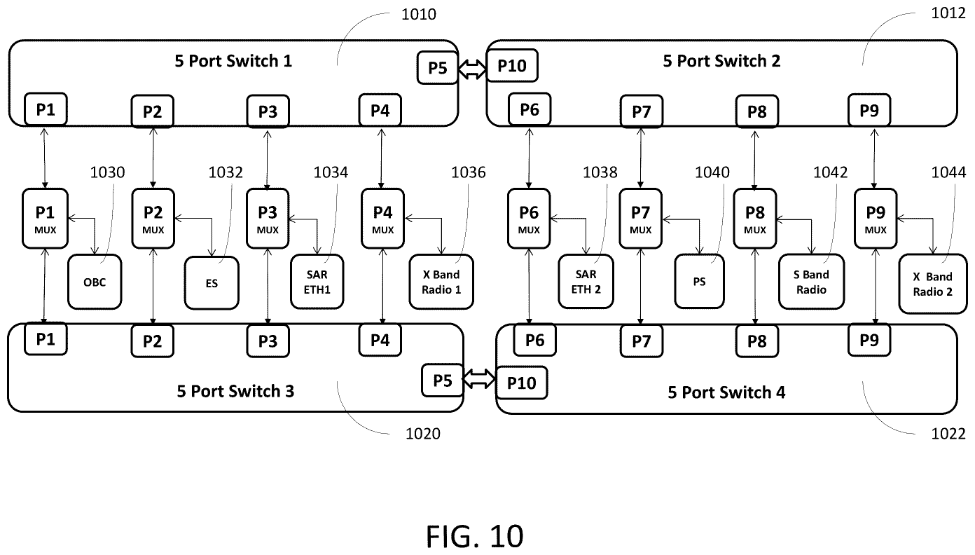

FIG. 10 illustrates an example network switch subsystem interconnect. Referring to FIG. 10, primary and redundant ethernet ports of compute nodes such as OBC 1030, edge server 1032 and PS 1040 may be individually multiplexed and connected or mapped to individual ethernet switch ports. Port mapping may be based on the following table.

| Ethernet Switch | Ethernet Port | Sub System |
|---|---|---|
| Ethernet switch 1 and | Port 1 | SAR Ethernet 1 |
| 3 | Port 2 | PS board |
| | Port 3 | OBC |
| | Port 4 | X Band Radio 1 |
| Ethernet switch 2 and | Port 6 | SAR Ethernet 2 |
| 4 | Port 7 | Edge Board |
| | Port 8 | S Band |
| | Port 9 | X Band Radio 2 |

Still referring to FIG. 10, some of the sub-systems may have dual ethernet ports (e.g., SAR Payload 1034, 1038) or the subs-system itself may have two instances (e.g., X-Band radio 1036, 1044). For such sub-systems, one port may be connected to the network switch 1010 and network switch 1020 pair, and the second port may be connected to the network switch 1012 and network switch 1022 pair to add a second level failsafe mechanism.

An example scenario uses the data path redundancy for mitigating network switch 1010 and 1020 failures. When the network switch 1010 and network switch 1020 failures are observed, OBS 1030 will automatically select network switch 1012 and network switch 1022 based on the MUX control by OBC 1030 and as per port assignments. SAR Payload's Ethernet 1034 may be accessible by the edge server 1032 board through active network switching. The edge server 1032 and PS 1040 may be interconnected though a 5 Gbps high speed USB 3.0 interface, thus providing another level of redundancy in data handling, allowing the PS 1040 board to retrieve SAR data via the edge server 1032 board. The edge server 1032 may still download data through the X-band radio 1044 and S-band radio 1042. The PS 1040 may also download the data through the X-band radio 1044 by routing the data through PS 1040 to edge server 1032 by the high speed USB 3.0 interface.

Another example scenario is using the data path redundancy for mitigating network switch 1012 and 1022 failures. When the network switch 1012 and network switch 1022 failures are observed, switches 1010 and 1020 will be active in this case based on the MUX control by OBC 1030 and as per port assignments. The SAR payload Ethernet 1034 is accessible by the PS 1040 board. PS 1040 may download the data though X-band radio 1036 interfaces. Edge server 1032 may download data through the X-band Radio 1036 by routing the data through PS 1040 to edge server 1032 by the high speed USB 3.0 interface.

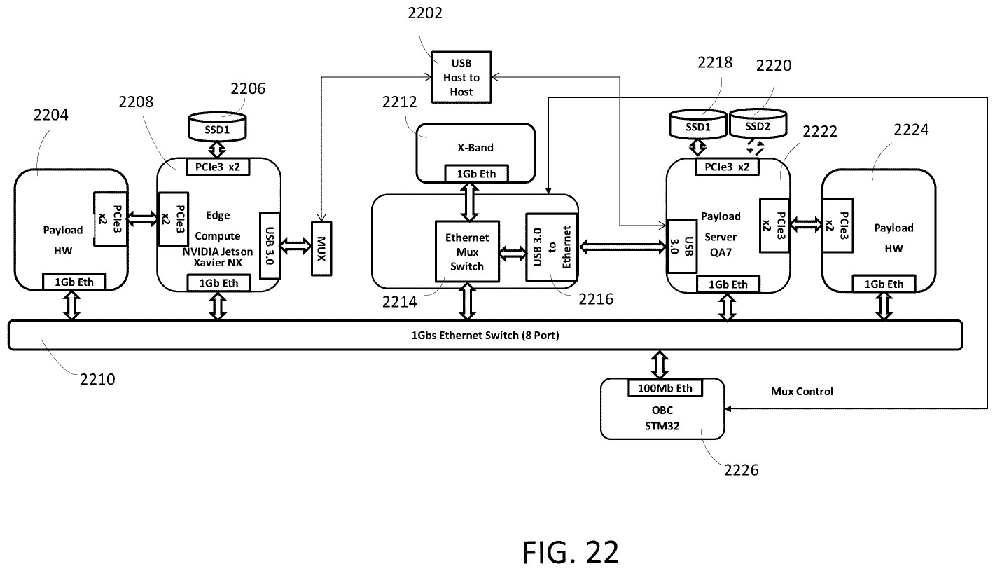

In the unlikely event that all four of the network switches 1010, 1012, 1020, and 1022 fail, SAR payload communication with PS and edge server will be disabled. Since a Multispectral Imaging (MSI) payload interface may be through PCIe G3, PS 1040 and edge server 1032 are able to communicate and perform data transfer from an MSI interface via PCIe G3 and download through X-band radio 1020. PS 1040 may download data to the X-band radio 1044 through the USB to an ethernet converter option. edge server 1032 and PS 1040 are interconnected through a USB3.0 Interface, so the edge server 1032 is able to perform a data transfer to PS 1040 through the USB interface and download data to the X-band Radio 1044 through USB to ethernet converter option of PS 1040, shown in FIG. 22.

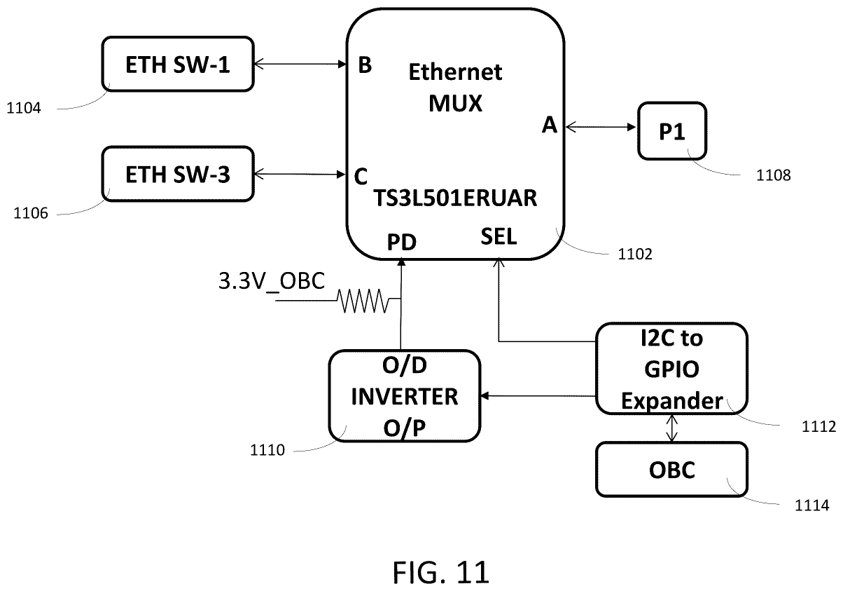

FIG. 11 illustrates an ethernet switch that controls multiplexing. Referring to FIG. 11, ethernet signals from the primary and the redundant switch may be multiplexed together. The ethernet multiplex switch 1102 may be controlled by the OBC 1114. The OBC 1114 controls the I/O pins PD by an O/D inverter 1110 and SEL by a I2C to GPIO expander 1112, based on the truth table below such that the ethernet multiplexer switch 1102 selects switch 1104 or switch 1106.

| PD | SEL | FUNCTION |
|---|---|---|
| LOW | LOW | Aₙ to Bₙ LED_Aₙ to LED Bₙ |
| LOW | HIGH | Aₙ to CₙLED_Aₙ to LED Bₙ |
| HIGH | X | HIZ |

In this way, the OBC 1114 controls the primary and redundant ethernet switch selection. Since OBC 1114 has control over this multiplexer interface, in case of a failure detected in the ethernet multiplexer switch 1102, the redundant switch will be selected and the network interface performs seamlessly. OBC 1114 applies the same selection logic for additional switches.

Ethernet may work up to a distance of 100 meters, but for satellite design, the typical length is usually less than 100 meters. Magnetic isolation for the MNI Signals provide ESD protection. The terminating end of the ethernet cable should have similar magnetic isolation for the ethernet port.

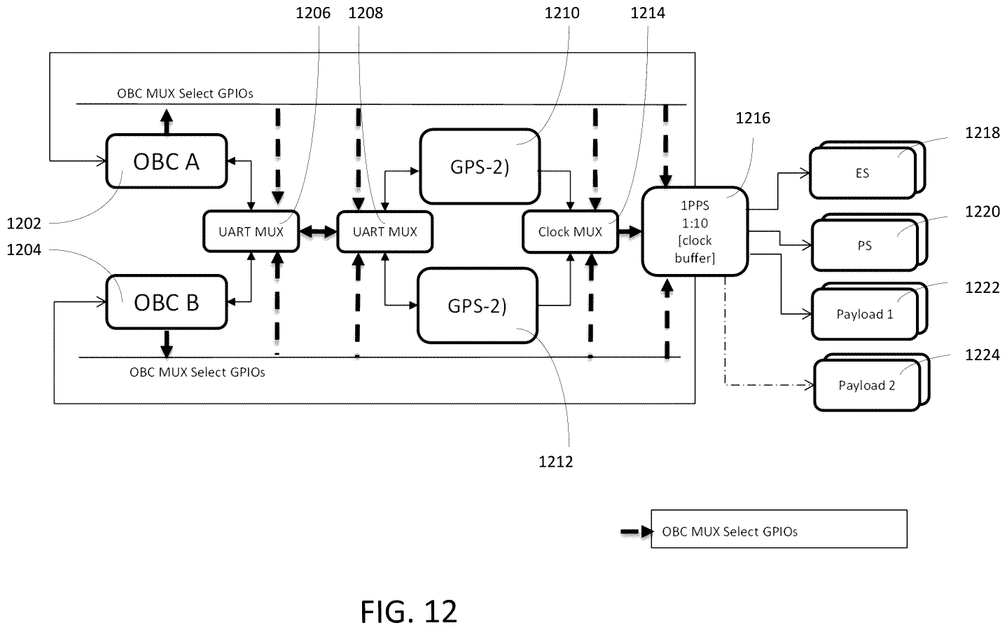

Satellite avionics designs may support two GPS modules, but only one module may be actively connected to the OBC at a time. The primary interface between GPS and OBC may be a UART Interface. The OBC and the GPS may be multiplexed together and interconnected as shown in FIG. 12. Referring to FIG. 12, to meet the unified system level time synchronization requirement, the pulse per second (PPS) clock buffer 1216 provides a PPS signal from the onboard GPS module which may be made available in the satellite avionics design. A redundant GPS module may be on board the satellite, with selection controlled by the active one of OBC 1202 or OBC 1204 through UART interface 1206. The GPS 1210 or GPS 1212 provides UTC time to the OBC 1202 and/or OBC 1204 for time sync. The active one of OBC 1202 or OBC 1204 may extract the UTC time information from the GPS 1210 or GPS 1212 and in turn provide time and synchronization information to other sub systems such as payloads 1222, 1224 such as SAR, MSI, or ADCS, edge server 1218 and PS 1220. The connection of the PPS signal may be supported via the general purpose I/Os (GPIOs) and related driver software to assist in time synchronization to the needed sub-system. As shown in FIG. 12, the PPS signal may be connected to OBC 1202, 1204, edge server 1218, PS 1220, a SAR and with one I/O reserved for MSI.

In some examples, a payload server may incorporate the high-performance QA7 processor and offer multiple I/O interface (PCIeG3, 1G Ethernet, CAN and USB 3.0) for connecting the payloads and other sub-systems. QA7 processor may support four PCIe G3 lanes. Flexible options to better utilize these four PCIe G3 IO lanes for connecting the payload hardware and the storage (SSD) may be utilized.

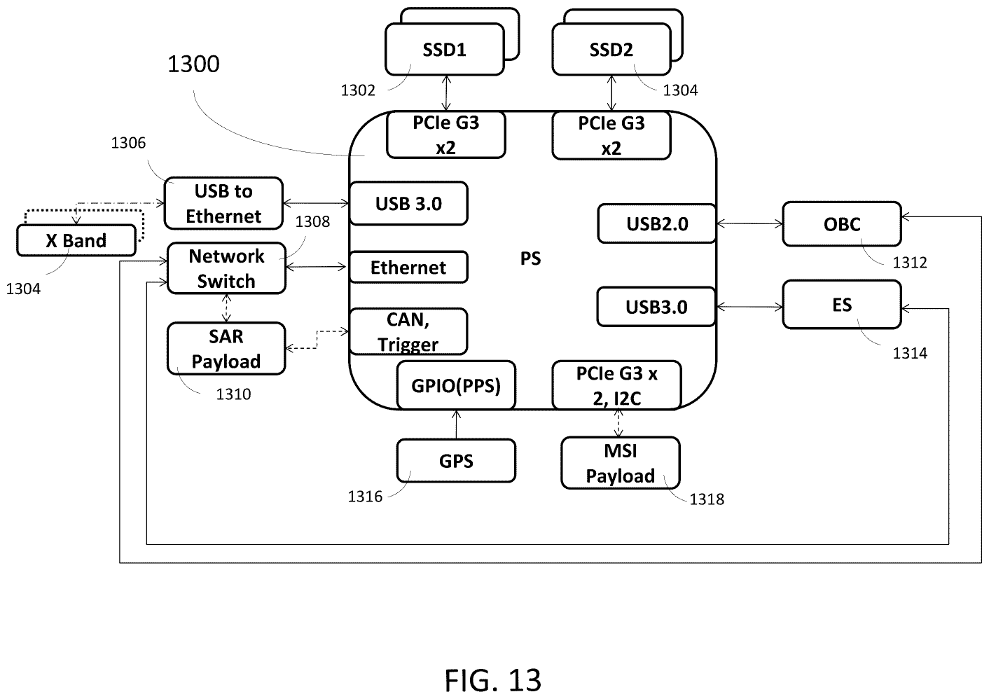

The payload server may enable the processing and management of payload data of the satellite avionics system. Redundancy may be built in for the payload server PS. FIG. 13 illustrates payload server interconnections. Referring to FIG. 13, payload server 1300 may be interconnected with OBC 1312 through a USB2.0 interface and/or though an ethernet interface, via network switch 1308. Payload server 1300 may be interconnected with edge server 1314 through USB 3.0 and/or through an ethernet interface, via network switch 1308. Payload server 1300 may be interconnected with SSDs 1302, 1304 through PCIe G3 interfaces. Payload server 1300 may be interconnected with X band radio 1304 and other subsystems through an ethernet interface, via network switch 1308. Additionally, the X band radio 1304 may be multiplexed and connected to the payload server 1300 through a USB to ethernet interface 1306. Payload server 1300 may be interconnected to payload 1318 through PCIe G3×2 lanes. PPS signals from GPS 1316 be transmitted to a GPIO of payload server 1300.

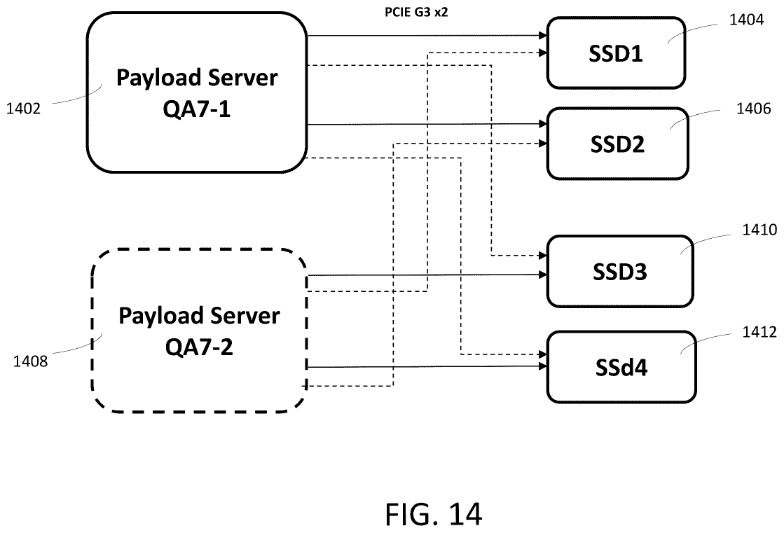

The satellite avionics system enables PCIe G3×2 interfaces for connecting SSDs to the payload server. This high-speed serial expansion bus enables fast and direct communication between the SSDs and the payload server, ensuring efficient data transfer and access. Furthermore, the satellite avionics system enables flexible design options for SSD interfacing with the payload server. The selection of the SSD is controlled by the on-board computer (OCB) through the multiplexer selection mechanism. FIG. 14 illustrates SSD interfaces that are interconnected to payload servers, but the payload hardware is not connected to a PS PCIe G3 interface. Referring to FIG. 14, in this case all of the four SSDs 1404, 1406, 1410, and 1410 are connected to the payload server 1402, but only two of the SSDs (1404 and 1406, or 1410 and 1412) can be accessed at the same time.

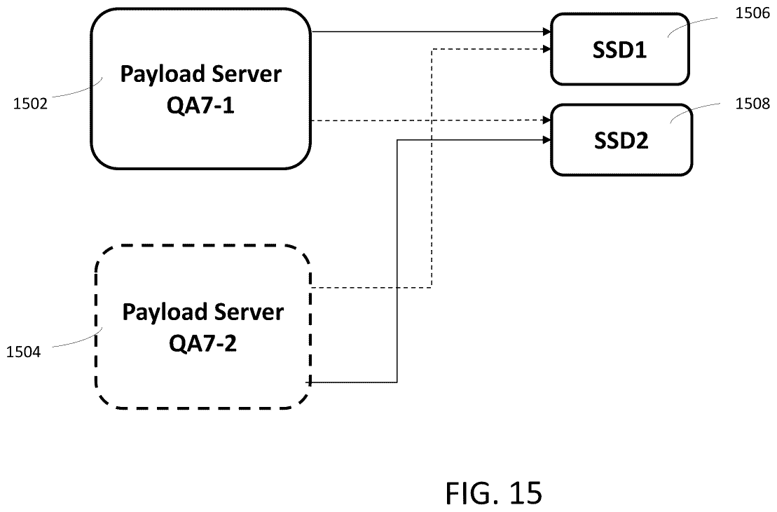

FIG. 15 illustrates SSD interfaces that are interconnected to payload servers through a PCIe G3×2 interface. Referring to FIG. 15, If payload server 1502 acts as a MSI payload data processing unit, then two SSDs 1506, 1508 are connected to the payload server 1502, such that only one of SSDs 1506, 1508 can be accessed at a time. In some embodiments, the payload server may assess the SSD connected to an edge server by using the high-speed data transfer interface USB3.0 and ethernet. The payload server and the edge server may transfer data through these interfaces, which enables the payload server to access to all SSDs in the system.

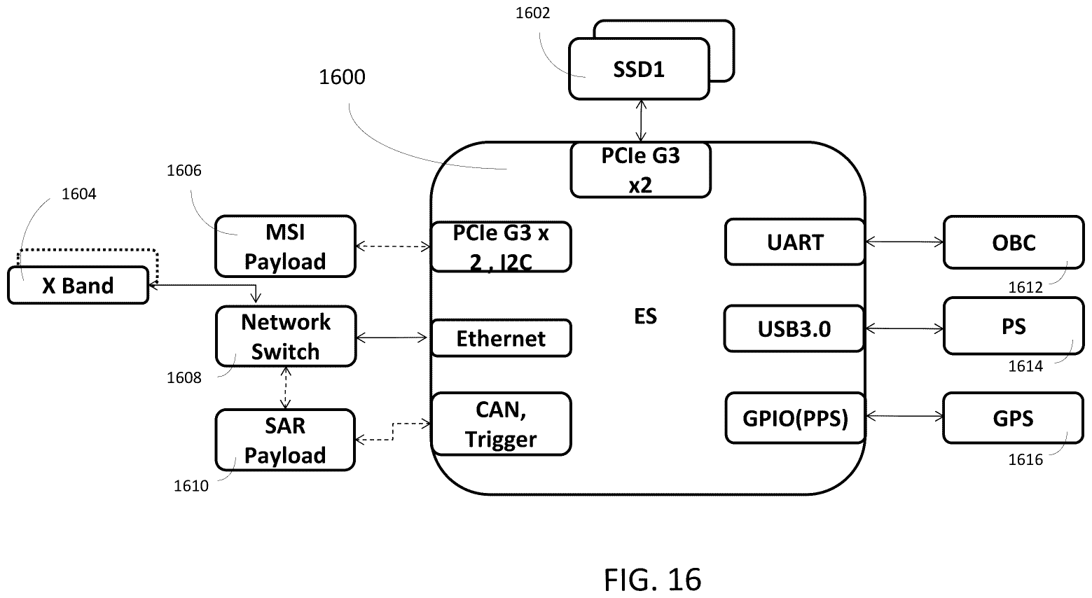

FIG. 16 illustrates edge server connectivity. Referring to FIG. 16, edge server 1600 may incorporate, for example, a Jetson Xavier NX as the edge compute. In some embodiments, two edge servers may be present and both may be powered ON simultaneously. Each edge server may enable two possible high speed data interfaces (1G Ethernet, PCIe G3 and/or USB) and a low speed interface like CAN for connecting the payload hardware and Storage (SSD 1602) and other sub-systems. The edge server 1600 may enable the processing and management of payload data of the satellite avionics system. In addition, the edge server also may have the AI capabilities for edge computing. When two or more edge compute nodes are present, both can be powered on simultaneously but the storage path to the SSD 1602 of only one edge server is selectable by the OBC 1612 at a time. The accessibility of SSD 1602 is limited to one edge server at a time as the SSDs 1602 connected to the two edge servers are multiplexers to increase the SSD access and storage capability in the overall system.

Still referring to FIG. 16, edge server 1600 may be interconnected with the OBC 1612 through a UART interface and/or via an ethernet interface through network switch 1608. Edge server 1600 may be interconnected with payload server 1614 through USB 3.0. Additionally, edge server 1600 also may be connected via an ethernet interface through network switch 1608. Edge server 1600 may be interconnected with SSDs 1602 through a PCIe G3 interface. Edge server 1600 may be interconnected with X band 1604 and other subsystems via an ethernet interface through network switch 1608. Edge server 1600 may be interconnected to a payload such as MSI payload 1606 through PCIe G3×2 lanes. PPS signals from GPS 1616 may multiplexed and transmitted to a GPIO interface of edge server 1600.

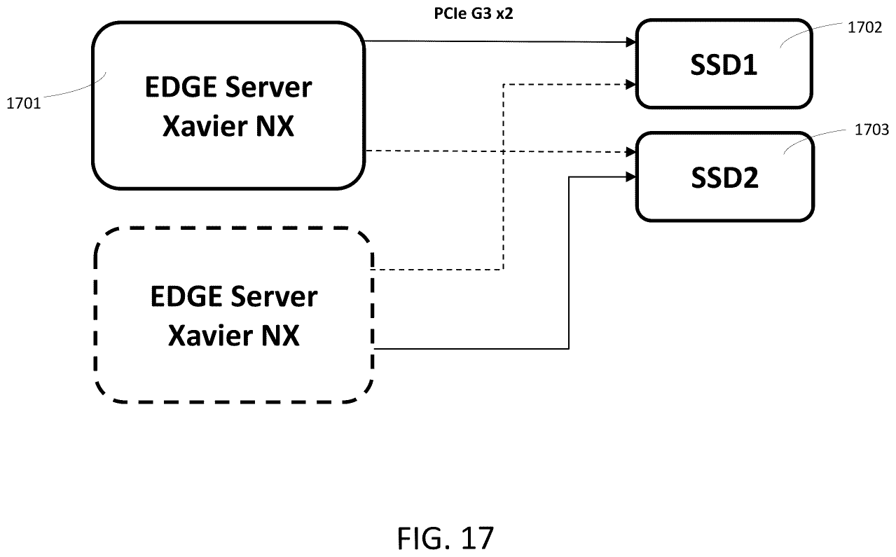

FIG. 17 illustrates SSD connectivity with an edge server. Referring to FIG. 17, the satellite avionics system enables PCIe G3×2 interfaces for connecting SSDs 1702, 1703 to the edge server 1701. This high-speed serial expansion bus enables fast and direct communication between the SSDs 1702, 1703 and the edge server 1701, ensuring efficient data transfer and access. The satellite avionics system enables two SSDs 1702, 1703 to connect with edge server 1701. The selection of SSD 1702 or SSD 1703 is controlled by the on-board computer (OCB) through a multiplexer selection mechanism. Edge server may assess the SSD 1702 and/or SSD 1703 connected to the payload server by using the high-speed data transfer interface USB3.0 and ethernet. Edge server 1701 and payload server may transfer data through these interfaces, which enables the edge server 1701 to access to the SSDs 1702, 1703 in the system.

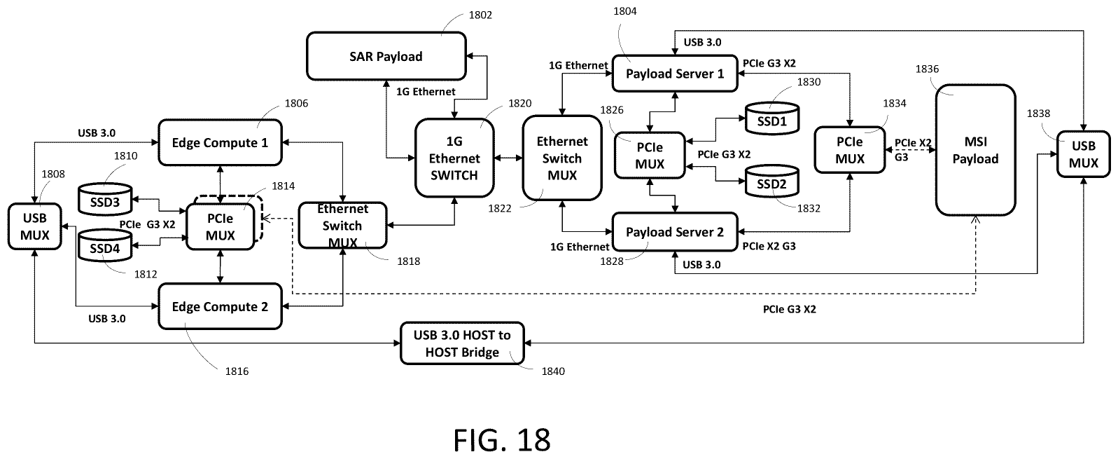

FIG. 18 illustrates payload hardware interconnects with computes and storage. Referring to FIG. 18, the SAR payload 1802 and the MSI payload 1836 are the payloads planned to integrate with the satellite avionics system, since the data processing of the payload data will be high for these payloads, the satellite avionics design provides flexibility in connecting these payloads to the payload servers 1824, 1828 and the edge servers 1808, 1816, depending on the data processing requirements. In addition, the satellite avionics design also provides an option to share the data processing across these two compute nodes through high-speed interface. The MSI payload connection is shown as a dotted line to indicate that the option is kept open for the MSI payload 1836 to be connected with either payload server 1824, 1828 or to an edge server 1806, 1816. From the hardware connectivity aspect, the PCIe G3×2 interface is made available from both payload server 1824, 1828 and/or edge server 1806, 1816, based on the data processing requirements and power budget availability for the MSI payload connection to be cabled.

Still referring to FIG. 18, payload servers 1824, 1828 and the edge servers 1808, 1816 will provide a 1 Gbps ethernet interface and the same is connected to a 1 Gbps network switch 1820. Since all the sub systems are connected to the Network switch payload servers 1824, 1828 and the edge servers 1808, 1816 can connect to the MSI payload 1836 and/or SAR payload 1802. This network interface enables high-speed data transfer across sub-systems that are interconnected to the network switch. Even though the theoretical maximum supported by the network switch is 1 Gbps, typical or achievable data rate can be up to 800 Mbps. The payload servers 1824, 1828 and the edge servers 1808, 1816 also provide 2 lanes of PCI3 gen 3 for payload hardware access. The PCIe G3 interface operates as a high-speed serial expansion bus and in this two PCIe G3×2 lanes are provided for payload hardware connectivity and the remaining two lanes are used for connecting the SSDs 1830, 1832, 1810, 1812. The PCIe G3×2 offers the 16 Gbps Data rate theoretically.

Still referring to FIG. 18, to support high speed interface between payload servers 1824, 1828 and the edge servers 1808, 1816, a USB 3.0 interface supporting a speed of 5 Gbps is multiplexed at both the payload servers 1824, 1828 and the edge servers 1808, 1816, and interconnected through the USB host IC 1840. This high-speed interface may be used as a high-speed data path between payload servers 1824, 1828 and the edge servers 1808, 1816 to distribute the data processing load.

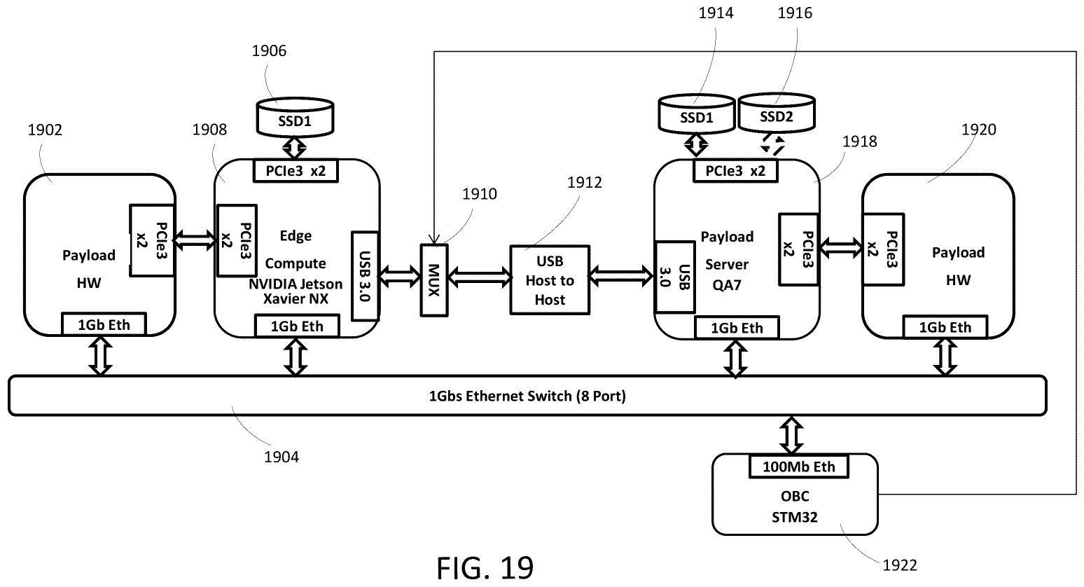

FIG. 19 illustrates a high speed interconnect of a payload server and an edge server. Referring to FIG. 19, A SAR payload may be connected to an ethernet switch 1904 to communicate with payload server 1918 and/or edge server 1908. The MSI payload uses a PCIe G3 interface as the data interface. The PCIeG3×2 I/O from both the payload server 1918 and the edge server 1908 provide flexibility to connect to the MSI payload from either payload server 1918 or edge server 1908. With respect to payload server storage, total there may be two SSDs 1914, 1916. In some embodiments, there may be four SSDs if the MSI is connected with edge server 1908 is connected to payload server 1918. The SSDs 1914, 1916 may be both accessed by payload server 1918. The selection of SSD is controlled by multiplexer selection from OBC 1922. Additionally, if payload server 1918 wants to access the SSD 1906 of edge server 1908, access may be done through USB 3.0.

Still referring FIG. 19, with respect to edge server storage, there may be two SSDs connected to edge server 1908, although only SSD 1906 is illustrated. If there are two SSDs, both SSDs can be accessed by the edge server 1908, but one SSD at a time. Selection of SSD is controlled by the multiplexer selection from OBC 1922. Additionally, if edge server 1908 wants to access the SSD 1914, 1916 of payload server 1918, it can be done through a USB 3.0 interconnect 1912 between payload server 1918 and edge server 1908. With this interconnectivity the satellite avionics provides extended flexibility for data connectivity and data storage, and data transfer options across the compute nodes as well as across the payload hardware.

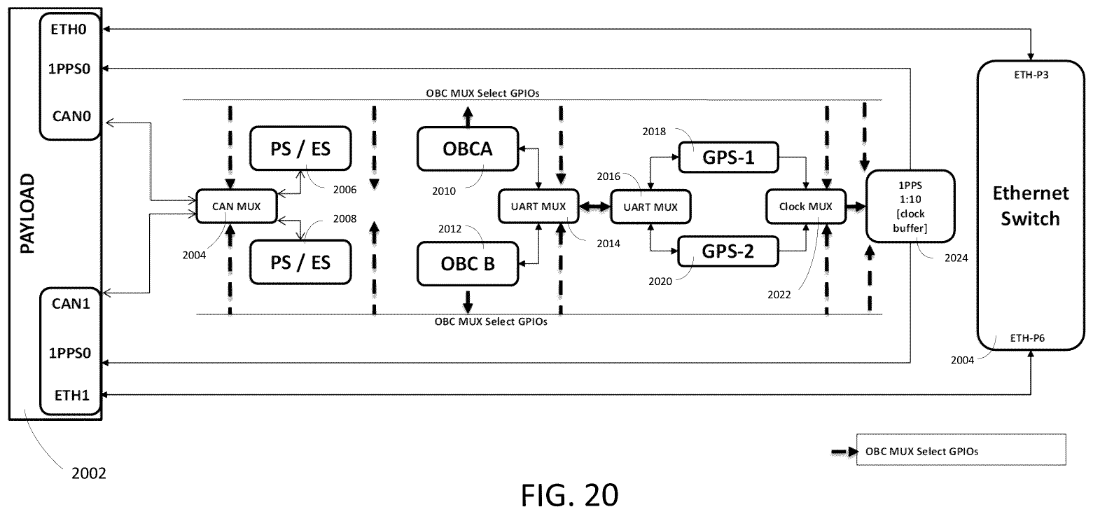

FIG. 20 illustrates payload connectivity in a satellite avionics system, for an example SAR payload. Referring to FIG. 20, SAR payload control interface connectivity for SAR payload 2002 supports primary and redundant interfaces for ethernet, IPPS and Controller Area Network (CAN) interfaces. Control interface CAN of SAR payload 2002 may be multiplexed by a CAN multiplexer from OBC 2010, 2012 and/or from payload server 2018 and connected to both the primary and the redundant CAN of SAR payload 2002. A IPPS sync signal from GPS 2018, 2020 is multiplexed by multiplexer 2016 and given to both primary and secondary PPS IO of SAR payload 2002. The IPPS sync signal from GPS 2018, 2020 may be multiplexed by multiplexer 2014 to connect to OBC 2010, 2012. Both the primary and redundant ethernet ports of SAR payload 2002 are connected to the individual ports of the ethernet switch 2004.

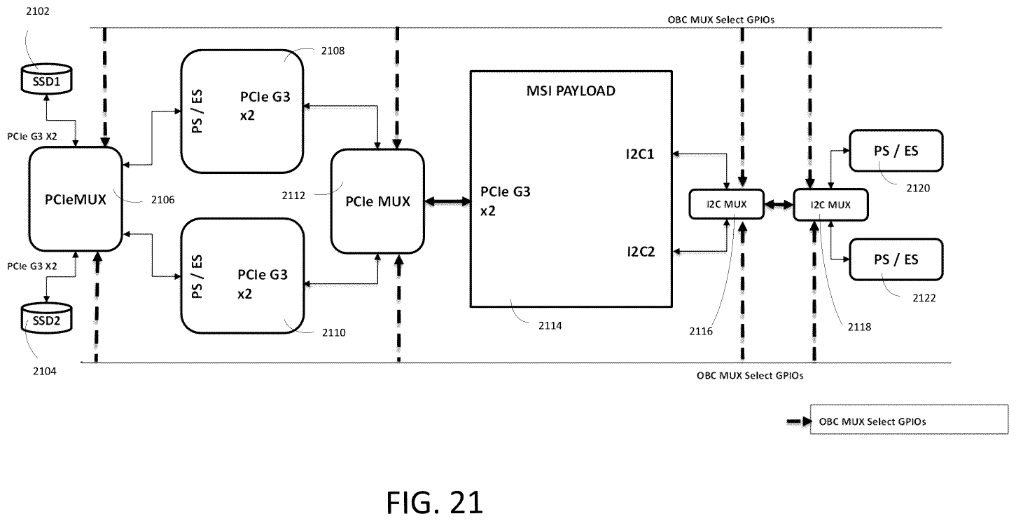

FIG. 21 illustrates data interface connectivity of the MSI payload. Referring to FIG. 21, the MSI payload 2114 supports primary and redundant I2C interfaces as the control interface to I2C multiplexers 2116, 2118 and PCIe G3×2 as the data path interface to PCIe multiplexer 2112. Based on the data processing unit selection, the PCIe G3×2 interfaces from a payload server/edge server 2108 or payload server/edge server 2110 will be multiplexed by multiplexer 2112 and connected to the MSI payload 2114 for data interface. Similarly, a control interface from an OBC is multiplexed and connected to the primary and redundant I2C interface of the MSI payload 2114. A PCIeMUX 2106 may select data from data storage 2102 or data storage 2104.

FIG. 22 illustrates an X-band radio data interface. Referring to FIG. 22, satellite avionics systems may enable one high speed data interface for a first X-Band radio and two high-speed data interfaces to connect with a second X-Band radio. FIG. 22 is a the high-level interface diagram for the second X-Band radio, where both data interface options may be enabled simultaneously. The X-Band radio may be dynamically controlled by the multiplexer select option from OBC 2226. The X-Band Radio 2212 is connected to the ethernet switch 2210 via an ethernet multiplexer 2214. The downlink data from the edge server 2208 or payload server 2222 may be transmitted through the ethernet switch 2210. The ethernet switch 2210 may provide a maximum theoretical throughput of 1 Gbps. However, the actual throughput may vary depending on the FIFO limitation in the ethernet switch 2210 and is typically expected to be around 800 Mbps. In this configuration, the X-Band Radio 2212 is connected to payload server 2222 via a USB 3.0 to Ethernet PHY (Physical Layer) converter 2216. The downlink data from the payload server 2222 is enabled through the USB 3.0 interface, converted into an ethernet interface. The maximum rate may be limited by the 1 Gbps ethernet interface at the X-Band Radio 2212 end. In this configuration, the peak throughput supported by the X-band Radio 2212 ethernet interface can be better leveraged and the applicable data transfer rate between the payload server 2222 and X-Band Radio 2212 can be achieved. This configuration does not experience data rate throttle between X-band data interface vs. other sub-system data transfers, improving overall performance.

Still referring to FIG. 22, edge server 2208 may be connected to storage 2206 and to payload hardware 2204. Payload server 2222 may be connected to storage 2218, 2220 and connected to payload hardware 2224. If the edge server 2208 wants to downlink data via X-band, then edge server 2208 can send the data to the payload server 2222 via the USB3.0 connection via the USB host-to host connection 2202 and then payload server 2222 may send the data to the X-band via the USB3.0 to ethernet interface 2216. This provides another failover and redundant data path for edge serve 2208. This data path may be applicable when ethernet port level issues are seen.

Satellite avionics system features may use a distributed computer architecture, allowing computational tasks to be efficiently processed across multiple nodes. On-board networking capabilities may be available to facilitate seamless communication between components. Built-in redundancy of various elements enhances reliability, ensuring continued operation even in the face of component failures. As described herein, the system is highly resilient, and capable of withstanding various challenges in the space environment. A flexible I/O interface accommodates diverse devices and connections. Compatibility with sensors, payload hardware, communication systems, and control systems is integrated. Furthermore, the system incorporates built-in on-board storage for data management. Multiplexer functionality is enabled and controlled by software, contributing to increased versatility and failsafe management.

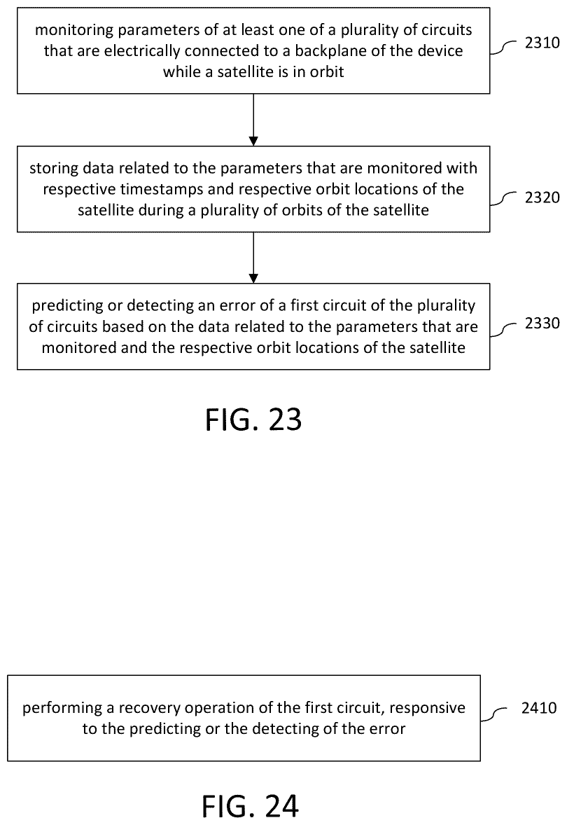

FIG. 23 is a flowchart of operations of a device configured for satellite on-orbit recovery. Referring to FIG. 23, parameters of at least one of a plurality of circuits that are electrically connected to a backplane of the device while a satellite is in orbit may be monitored, at block 2310. Data related to the parameters that are monitored may be stored with respective timestamps and respective orbit locations of the satellite during a plurality of orbits of the satellite, at block 2320. An error may be predicted or detected of a first circuit of the plurality of circuits based on the data related to the parameters that are monitored and the respective orbit locations of the satellite, at block 2330.

FIG. 24 is a flowchart of operations of a device configured for satellite on-orbit recovery. Referring to FIG. 24, a recovery operation of the first circuit may be performed, responsive to the predicting or the detecting of the error, at block 2410.

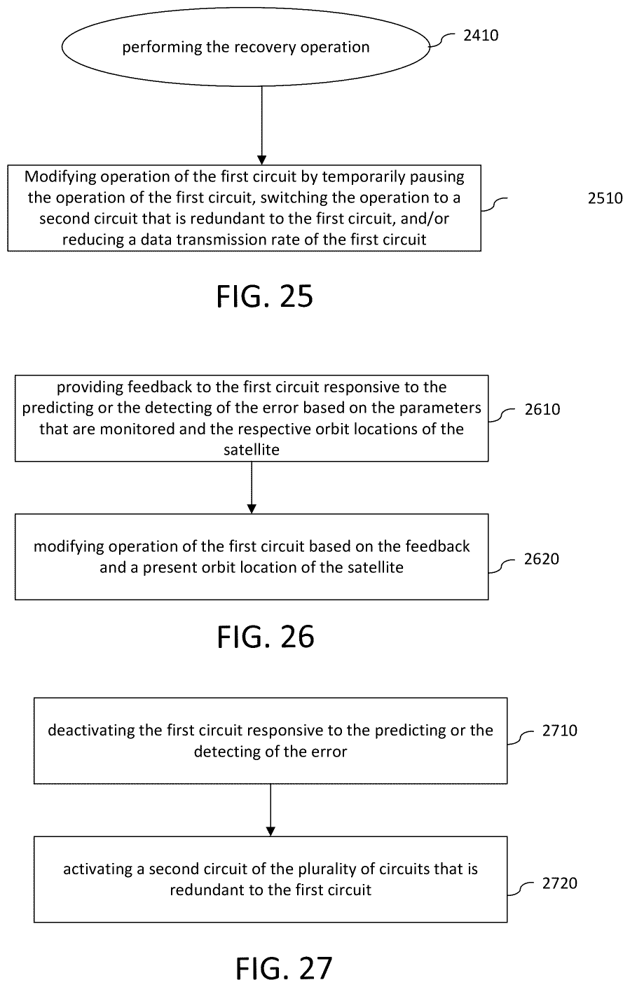

FIG. 25 is a flowchart of operations of a device configured for satellite on-orbit recovery. Referring to FIG. 25, performing the recovery operation of block 2410 may include modifying operation of the first circuit by temporarily pausing the operation of the first circuit, switching the operation to a second circuit that is redundant to the first circuit, and/or reducing a data transmission rate of the first circuit, at block 2510.

FIG. 26 is a flowchart of operations of a device configured for satellite on-orbit recovery. Referring to FIG. 26, feedback may be provided to the first circuit responsive to the predicting or the detecting of the error based on the parameters that are monitored and the respective orbit locations of the satellite, at block 2610. Operation of the first circuit may be modified based on the feedback and a present orbit location of the satellite, at block 2620. The feedback may include at least one of satellite location, data rate of data transmitted by the first circuit, or processing load of the first circuit.

FIG. 27 is a flowchart of operations of a device configured for satellite on-orbit recovery. Referring to FIG. 27, the first circuit may be deactivated responsive to the predicting or the detecting of the error, at block 2710. A second circuit of the plurality of circuits that is redundant to the first circuit may be activated, at block 2720.

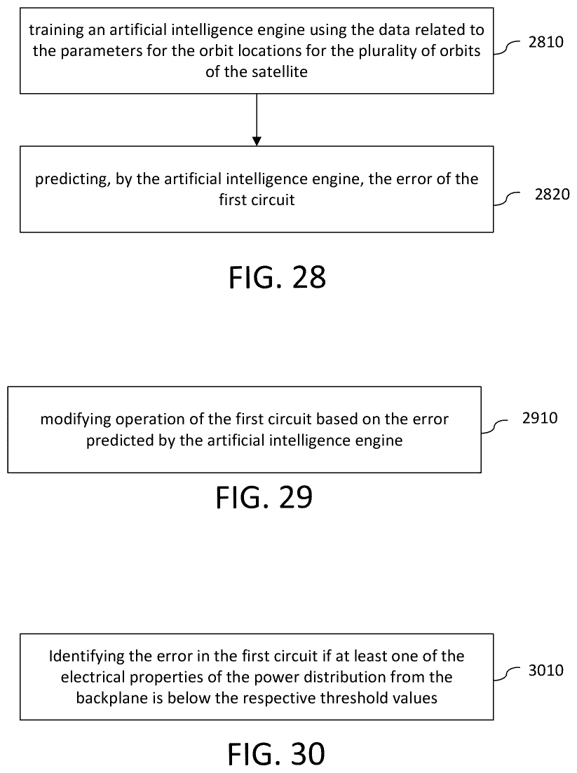

FIG. 28 is a flowchart of operations of a device configured for satellite on-orbit recovery. Referring to FIG. 28, an artificial intelligence engine may be trained using the data related to the parameters for the orbit locations for the plurality of orbits of the satellite, at block 2810. The artificial intelligence engine may predict the error of the first circuit, at block 2820.

FIG. 29 is a flowchart of operations of a device configured for satellite on-orbit recovery. Referring to FIG. 29, operation of the first circuit may be modified based on the error predicted by the artificial intelligence engine, at block 2910.

FIG. 30 is a flowchart of operations of a device configured for satellite on-orbit recovery. Referring to FIG. 30, the parameters may include electrical properties of power distribution from the backplane to ones of the plurality of circuits. The error of the first circuit may be identified if at least one of the electrical properties of the power distribution from the backplane is below respective threshold values, at block 3010.

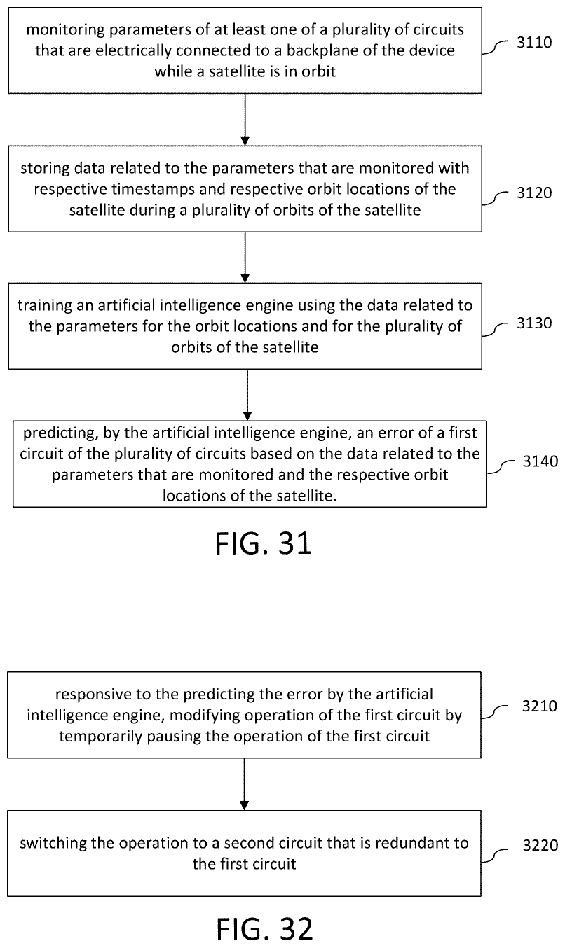

FIG. 31 is a flowchart of operations of a device configured for satellite on-orbit recovery. Referring to FIG. 31, parameters of at least one of a plurality of circuits that are electrically connected to a backplane of the device while a satellite is in orbit may be monitored, at block 3110. Data related to the parameters that are monitored with respective timestamps and respective orbit locations of the satellite during a plurality of orbits of the satellite may be stored, at block 3120. An artificial intelligence engine may be trained using the data related to the parameters for the orbit locations and for the plurality of orbits of the satellite, at block 3130. The artificial intelligence engine may predict an error of a first circuit of the plurality of circuits based on the data related to the parameters that are monitored and the respective orbit locations of the satellite, at block 3140.

FIG. 32 is a flowchart of operations of a device configured for satellite on-orbit recovery. Referring to FIG. 32, responsive to the predicting the error by the artificial intelligence engine, operation of the first circuit may be modified by temporarily pausing the operation of the first circuit and/or switching the operation to a second circuit that is redundant to the first circuit, at block 3220.

### FURTHER EMBODIMENTS

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements, and elements should not be limited by these terms; rather, these terms are only used to distinguish one element from another element. Thus, a first element discussed could be termed a second element without departing from the scope of the present inventive concepts.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuit,” “circuitry,” “a module” or variants thereof.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope of the present disclosure.

What is claimed is:

1. A device configured for satellite on-orbit recovery, the device comprising:
a plurality of circuits that are electrically connected to a backplane of the device wherein the device is configured to operate in a satellite; and
a controller configured to monitor parameters of at least one of the plurality of circuits, and configured to store the parameters that are monitored with respective timestamps and respective orbit locations of the satellite,
wherein the controller is further configured to identify an error of a first circuit of the plurality of circuits based on the parameters that are monitored and the respective orbit locations of the satellite.

2. The device configured for satellite on-orbit recovery of claim 1, wherein the controller is further configured to perform a recovery operation on the first circuit, responsive to predicting or detecting the error.

3. The device configured for satellite on-orbit recovery of claim 2, wherein the recovery operation comprises modifying operation of the first circuit by temporarily pausing the operation of the first circuit, switching the operation to a second circuit of the plurality of circuits that is redundant to the first circuit, and/or reducing data transmission rate of the first circuit.

4. The device configured for satellite on-orbit recovery of claim 1, wherein the controller is further configured to provide feedback to the first circuit responsive to predicting or detecting the error based on the parameters that are monitored and the respective orbit locations of the satellite.

5. The device configured for satellite on-orbit recovery of claim 4, wherein an operation of the first circuit is modified based on the feedback and one of the respective orbit locations of the satellite.

6. The device configured for satellite on-orbit recovery of claim 5, wherein the feedback comprises at least one of satellite location, data rate of data transmitted by the first circuit, or processing load of the first circuit.

7. The device configured for satellite on-orbit recovery of claim 4, wherein the first circuit is deactivated responsive to the predicting or detecting the error, and a second circuit that is redundant to the first circuit is activated.

8. The device configured for satellite on-orbit recovery of claim 1, wherein data related to the parameters of ones of the plurality of circuits are stored for a plurality of orbit locations and/or for a plurality of orbits of the satellite, and
wherein the data related to the parameters for the plurality of orbit locations and/or for the plurality of orbits of the satellite are used to train an artificial intelligence engine, and
wherein the artificial intelligence engine is configured to predict the error of the first circuit.

9. The device configured for satellite on-orbit recovery of claim 8, wherein the controller is configured to modify operation of the first circuit based on the error predicted by the artificial intelligence engine.

10. The device configured for satellite on-orbit recovery of claim 1, wherein the parameters comprise electrical properties of power distribution from the backplane to ones of the plurality of circuits, and
wherein the error of the first circuit is identified if at least one of the electrical properties of the power distribution from the backplane is below respective threshold values.

11. A method of operating a device configured for satellite on-orbit recovery, the method comprising:
monitoring parameters of at least one of a plurality of circuits that are electrically connected to a backplane of the device while a satellite is in orbit;
storing data related to the parameters that are monitored with respective timestamps and respective orbit locations of the satellite during a plurality of orbits of the satellite; and
identifying an error of a first circuit of the plurality of circuits based on the data related to the parameters that are monitored and the respective orbit locations of the satellite.

12. The method of claim 11, further comprising:
performing a recovery operation of the first circuit, responsive to predicting or detecting of the error.

13. The method of claim 12, wherein performing the recovery operation comprises:
modifying operation of the first circuit by temporarily pausing the operation of the first circuit, switching the operation to a second circuit of the plurality of circuits that is redundant to the first circuit, and/or reducing a data transmission rate of the first circuit.

14. The method of claim 11, further comprising:
providing feedback to the first circuit responsive to predicting or detecting of the error based on the parameters that are monitored and the respective orbit locations of the satellite; and
modifying operation of the first circuit based on the feedback and a present orbit location of the satellite,
wherein the feedback comprises at least one of satellite location, data rate of data transmitted by the first circuit, or processing load of the first circuit.

15. The method of claim 11, further comprising:
deactivating the first circuit responsive to predicting or detecting of the error; and
activating a second circuit of the plurality of circuits that is redundant to the first circuit.

16. The method of claim 11, further comprising:
training an artificial intelligence engine using the data related to the parameters for the respective orbit locations for the plurality of orbits of the satellite; and
predicting, by the artificial intelligence engine, the error of the first circuit.

17. The method claim 16, further comprising:
modifying operation of the first circuit based on the error predicted by the artificial intelligence engine.

18. The method claim 11, wherein the parameters comprise electrical properties of power distribution from the backplane to ones of the plurality of circuits, the method further comprising:
identifying the error of the first circuit if at least one of the electrical properties of the power distribution from the backplane is below respective threshold values.

19. A method of operating a device configured for satellite on-orbit recovery, the method comprising:
monitoring parameters of at least one of a plurality of circuits that are electrically connected to a backplane of the device while a satellite is in orbit;
storing data related to the parameters that are monitored with respective timestamps and respective orbit locations of the satellite during a plurality of orbits of the satellite;
training an artificial intelligence engine using the data related to the parameters for the orbit locations and for the plurality of orbits of the satellite; and
predicting, by the artificial intelligence engine, an error of a first circuit of the plurality of circuits based on the data related to the parameters that are monitored and the respective orbit locations of the satellite.

20. The method claim 19, further comprising:
responsive to the predicting the error by the artificial intelligence engine, modifying operation of the first circuit by temporarily pausing the operation of the first circuit and/or switching the operation to a second circuit of the plurality of circuits that is redundant to the first circuit.
